(19) United States
(12) Patent Application Publication
(10) Pub. No.: US 2013/0121230 A1
(43) Pub. Date: May 16, 2013

(54) SYNCHRONIZATION CONTROL APPARATUS AND METHOD FOR MULTICAST AND BROADCAST SERVICES

(71) Applicant: Kwang-Yong KIM, Daejeon-si (KR)

(72) Inventor: Kwang-Yong KIM, Daejeon-si (KR)

(73) Assignee: Electronics and Telecommunications Research Institute, Daejeon-si (KR)

(21) Appl. No.: 13/546,137

(22) Filed: Jul. 11, 2012

(30) Foreign Application Priority Data
Nov. 10, 2011 (KR) 10-2011-0117194

(51) Int. Cl. H04W 4/06

(52) U.S. Cl. 370/312

(57) ABSTRACT

A synchronization control method for MBS in an access network gateway is provided. The synchronization control method generates content unit data for multicast broadcasting when external data is input, generates a sync rule to be used in one or more base stations, and transmits the content unit data for multicast broadcasting and a sync rule notification message to the one or more base stations.

### CROSS-REFERENCE TO RELATED APPLICATION

This application claims the benefit under 35 U.S.C. §119(a) of Korean Patent Application No. 10-2011-0117194, filed on Nov. 10, 2011, the entire disclosure of which is incorporated herein by reference for all purposes.

BACKGROUND

1. Field

The following description relates to an Internet protocol television (IPTV) service technology, and more particularly, to a synchronization control apparatus and method for multicast and broadcast services (MBS).

2. Description of the Related Art

IPTV technology, in which mobility has been added to IPTVs, is technology that provides a broadcasting service over a wireless Internet network so as to enable users to receive high-quality TV, video on demand (VoD), and data services anywhere at any time, in a high-speed mobile environment. To improve the performance of an access network, however, a terminal in a single frequency network domain needs to operate in a macrodiversity mode for providing a high-quality mobile IPTV service by reducing interference between cells and decreasing frequency of handover.

The macrodiversity mode denotes a technique in which a plurality of base stations respectively disposed in a plurality of cells transmit the same content to mobile terminals located in a center cell, and thus enhances a content transmission gain, in MBS based on Wibro. To this end, the range of base stations in an area that transmit the same content to one mobile terminal denotes an MBS zone. In this case, data transmitted by a plurality of base stations in the MBS zone are synchronized in units of symbols, and a signal is added to the data by macrodiversity. Therefore, the reception performance of a mobile terminal outside a cell is also improved. To this end, a plurality of base stations need to transmit common multicast/broadcast data in a synchronized type. That is, a plurality of base stations are required to transmit the same broadcasting packet by using the same transmission scheme (symbol, sub channel, modulation, etc.) at the same time.

However, technology for synchronizing data transmitted from a plurality of base stations in an MBS zone in units of symbols for macrodiversity in a mobile IPTV service has not yet been proposed.

### SUMMARY

The following description relates to a synchronization control apparatus and method that synchronize and transmit data, transmitted from a plurality of base stations in an MBS zone, in units of symbols for macrodiversity in a mobile IPTV service.

In one general aspect, a synchronization control method for multicast and broadcast services (MBS) in an access network gateway includes: generating content unit data for multicast broadcasting when external data is input; generating a sync rule to be used in one or more base stations; and transmitting the content unit data for multicast broadcasting and a sync rule notification message to the one or more base stations.

In another general aspect, a multicast and broadcast synchronization control method in a base station includes: receiving content unit data for multicast broadcasting and a sync rule notification message including sync rule information from an access network gateway; converting the received content unit data for multicast broadcasting into data of a physical burst unit capable of being wirelessly transmitted to a mobile terminal; and transmitting the converted data of the physical burst unit to the mobile terminal in synchronization with a transmission time of another base station, on the basis of the sync rule information.

In another general aspect, an access network gateway apparatus for controlling multicast and broadcast synchronization includes: a data distributor configured to generate content unit data for multicast broadcasting with input data, and distribute and transmit the content unit data to a plurality of base stations; and a sync controller configured to generate sync rule information to be executed by the base stations on the basis of the content unit data of multicast broadcasting output from the data distributor, add the sync rule information into a sync rule notification message, and transmit the sync rule notification message to the base stations.

In another general aspect, a base station apparatus for controlling multicast and broadcast synchronization includes: a data receiver configured to receive content unit data for multicast broadcasting from an access network gateway to output payload data in which a header has been removed from the received data; an upper sync executor configured to receive a sync rule notification message including sync rule information from the access network gateway, and generate an MAC packet data unit and an MAC burst with the payload data output from the data receiver according to the sync rule information; and a lower sync executor configured to generate data of a physical burst unit with the MAC packet data unit and the data of the MAC burst unit, and transmit the generated data to one mobile terminal to be synchronized with another base station at certain timing intervals according to the sync rule information.

Other features and aspects will be apparent from the following detailed description, the drawings, and the claims.

### BRIEF DESCRIPTION OF THE DRAWINGS

FIG. 1 is a block diagram of a communication system including an MBS synchronization control apparatus for a mobile IPTV service.

FIGS. 2A and 2B are flowcharts for describing a synchronization control method between an access network and a base station for MBS in a mobile IPTV service in accordance with an embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will suggest themselves to those of ordinary skill in the art. Also, descriptions of well-known functions and constructions may be omitted for increased clarity and conciseness.

Hereinafter, embodiments of the present invention will be described with reference to the accompanying drawings in detail.

The present invention provides a synchronization control apparatus and method that allow a plurality of base stations to synchronize and transmit the same MBS data to one mobile terminal in the same transmission scheme (symbol, sub channel, modulation, etc.) at the same time for a mobile IPTV service. Accordingly, a macrodiversity signal is improved.

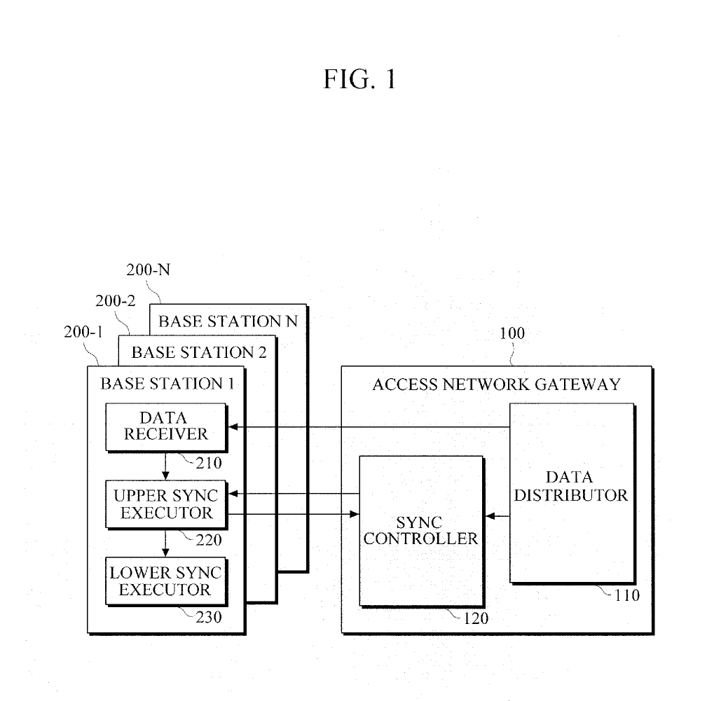

FIG. 1 is a block diagram of a communication system including an MBS synchronization control apparatus for a mobile IPTV service.

Referring to FIG. 1, an access network gateway (ASN G/W) 100 is connected to one or more base stations (BS) 200-1 to 200-N, and generates and transmits a sync rule in order for the data transmission of the base stations 200-1 to 200-N to be synchronized. The one or more base stations 200-1 to 200-N synchronize and transmit the same data to one mobile terminal according to the sync rule transmitted from the access network gateway 100.

In detail, the access network gateway 100 includes a data distributor (distribution data path function: distribution DPF) 110 and a sync controller 120. Each of the base stations 200-1 to 200-N includes a data receiver 210, an upper sync executor (USE) 220, and a lower sync executor (LSE) 230.

The data distributor 110 distributes and transmits MBS data, input from the access network gateway 100, to the base stations 200-1 to 200-N. The data distributor 110 bundles the input MBS data in units of a service data unit (SDUs) for each service flow, and allocates the bundled MBS data to one multicast connection identification (MCID) to generate data of a content unit for multicast broadcasting. Here, data bundled in units of SDUs for each MCID are generic-routing-encapsulated.

The sync controller 120 removes generic routing encapsulation (GRE) and receives a non-encapsulated MBS data packet from the data distributor 110. The sync controller 120 generates MBS burst timing information and a sync control rule that will be executed by the upper sync executor 220 included in each of the base stations 200-1 to 200-N, on the basis of the non-encapsulated MBS data packet. The sync controller 120 performs an MBS burst timing control function, an MBS burst scheduling function, a function of determining a physical layer message and media access control (MAC) layer message of each MBS burst, and a function of determining a method that appropriately maps MBS data to the MAC layer and the physical layer.

The data receiver 210 removes GRE from GR-encapsulated MBS data input from the data distributor 110, and transmits the other data to the upper sync executor 220 included in the same base station.

The upper sync executor 220 receives MBS data from the data receiver 210 and receives sync control information and MBS data transmission timing information from the sync controller 120, thereby configuring MBS MAC, a protocol data unit (PDU), and an MBS MAC burst.

An SDU is fragmented into a plurality of SDUs according to the size thereof and a fragmentation sub header (FSH) is attached to a packet header, or one SDU is packaged and then a packing sub header (PSH) is attached to the packet header, whereupon a generic MAC header (GMH) is finally attached to the packet header, and thus, a final MAC PDU is generated. Therefore, MBS MAC MAP information element (IE), MBS MAC MAP, and MBS MAC data IE are configured, and thus, an MAC burst is generated.

The lower sync executor 230 configures an MBS physical burst with the MAC burst received from the upper sync executor 220 and allocates the MBS physical burst to an MBS physical permutation zone for configuring. Here, the data position and size of the MBS physical permutation zone are configured with a plurality of continuous orthogonal frequency division multiple access (OFDMA) symbols and in the two-dimensional (2D) structure of a plurality of continuous sub channels.

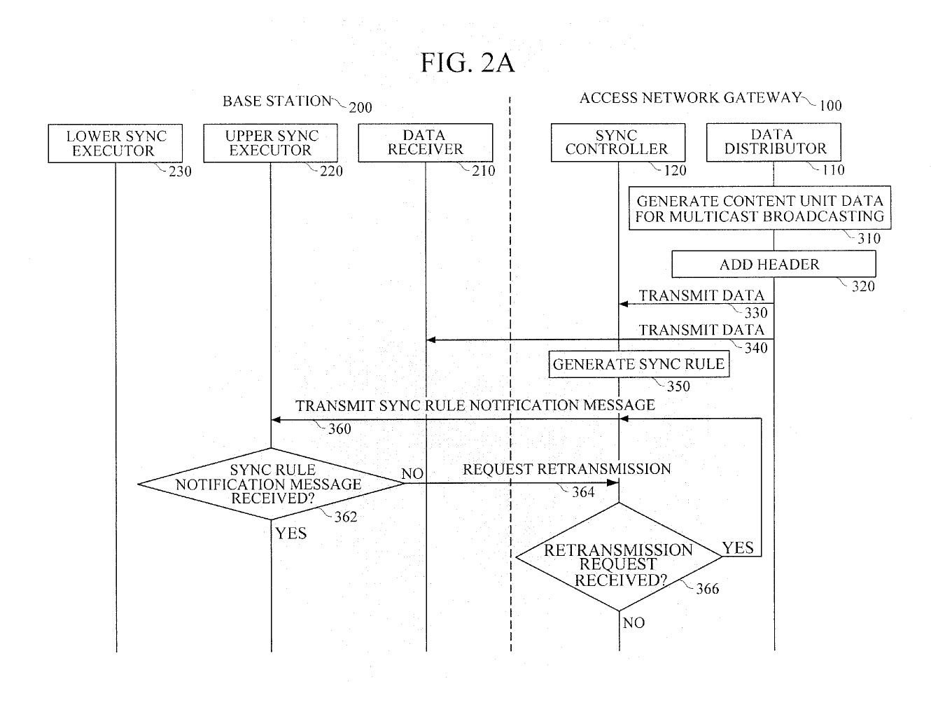

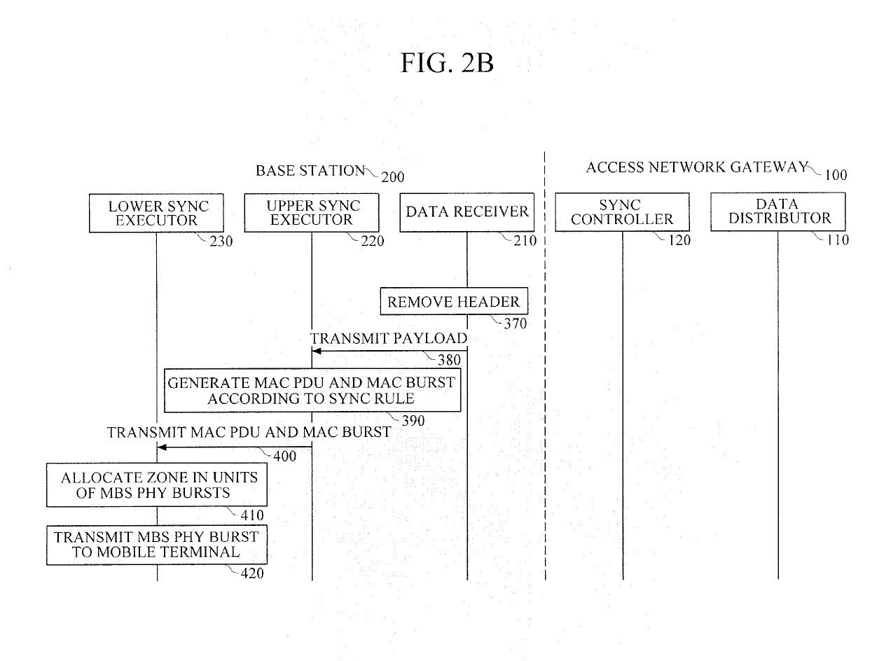

FIGS. 2A and 2B are flowcharts for describing a synchronization control method between an access network and a base station for MBS in a mobile IPTV service in accordance with an embodiment of the present invention.

Referring to FIG. 2A, the data distributor 110 disposed in the access network gateway 100 bundles MBS input data in units of SDUs for each service flow, and allocates one MCID to each of the MBS input data, thereby generating content unit data for multicast broadcasting in operation 310. Then, the data distributor 110 attaches a GRE header to the data bundled in units of SDUs for each MCID and attaches an IP header thereto in operation 320.

In operation 330, the data distributor 110 transmits a GRE header with no IP header attached thereto and the other payload data to the sync controller 120. In operation 340, the data distributor 110 transmits the data, to which the IP header and the GRE header have been attached, to the data receiver 210 included in each of the base stations 200-1 to 200-N.

In operation 350, the sync controller 120 receives the GRE header and the other payload data other than the IP header from the data distributor 110, and generates an MBS PDU generation rule, a MBS burst generation timing control rule, and a resource allocation scheduling control rule that are executed by the upper sync executor 220 and lower sync executor 230 of each base station, on the basis of the GRE header and the other payload data. That is, a quality of service (QoS) scheduler generates a control rule configuring the MAC PDU, a scheduling rule for determining a PHY burst allocation zone in an MBS PHY permutation zone, and a timing control rule for determining an MAC burst generation time on the basis of resource allocation scheduling information.

In operation 360, the sync controller 120 transmits the generated MBS sync control rules as a rule notification message to the upper sync executor 220. The rule notification message includes: a start time that allows an MAC burst to be generated for simultaneously sending the MAC burst to the base stations 200-1 to 200-N; a rule that allows MAC bursts to be generated at certain intervals; information that configures an MAC PDU by packaging or fragmenting SDUs that are bundled for each service flow and sent from an MBS data receiver; and scheduling allocation information for scheduling an MAC burst in units of MBS bursts in a PHY permutation zone.

In operation 362, the upper sync executor 220 determines whether a sync rule notification message is received from the sync controller 120.

When it is determined in operation 362 that the sync rule notification message is not received, the upper sync executor 220 requests retransmission of the sync rule notification message from the sync controller 120 in operation 364. On the other hand, when it is determined in operation 362 that the sync rule notification message is received, the upper sync executor 220 proceeds to operation 370 of FIG. 2B.

In operation 366, the sync controller 120 determines whether the retransmission request is received.

When it is determined in operation 366 that the retransmission request is received, the sync controller 120 again performs operation 360.

Referring to FIG. 2B, the data receiver 210 included in each base station removes the IP header and the GRE header from the MBS data that is received from the data distributor 110 in operation 370. Furthermore, the data receiver 210 transmits the other payload data to the upper sync executor 220 in operation 380.

In operation 390, the upper sync executor 220 configures an MAC PDU with the payload data received from the data receiver 210, according to the sync rule notification message including the sync control rule information received from the sync controller 120, and generates the MAC PDU in units of MAC bursts. That is, the upper sync executor 220 uses information that configures an MAC PDU by packaging or fragmenting SDUs bundled for each service flow among the sync rule notification message, a start time that allows an MAC burst to be generated in units of MAC PDUs, and a rule that allows MAC bursts to be generated at certain intervals.

Although not shown, when the sync rule notification message is not received from the sync controller 120, the upper sync executor 220 requests retransmission of the sync rule notification message from the sync controller 120.

Referring again to FIG. 2, the upper sync executor 220 configures an MAC PDU and retransmits the MAC PDU in units of MAC bursts to the lower sync executor 230 in operation 400. In operation 410, the lower sync executor 230 allocates the MAC PDU and the MAC burst, generated by the upper sync executor 220, to an MBS PHY permutation zone in units of MBS PHY bursts according to an MBS PHY burst allocation zone scheduling rule received from the sync controller 120. In operation 420, the lower sync executor 230 stores an MBS PHY burst in a first in first out (FIFO) buffer in order of generation, and transmits the MBS PHY burst to a mobile terminal in synchronization with an MBS PHY burst (which is stored in an FIFO buffer of another base station) at certain timing intervals.

According to the present invention, a plurality of base stations transmit common MBS data in a type, where the same broadcasting packets are synchronized, by using the same transmission scheme (symbol, sub channel, modulation, etc.) at the same time according to a sync control signal from an access network gateway. Accordingly, a macrodiversity signal is improved, and thus, a mobile IPTV service based on Wibro and WiFi networks can be provided.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A synchronization control method for multicast and broadcast services (MBS) in an access network gateway, comprising:
generating content unit data for multicast broadcasting when external data is input;
generating a sync rule to be used in one or more base stations; and
transmitting the content unit data for multicast broadcasting and a sync rule notification message to the one or more base stations.

2. The synchronization control method of claim 1, wherein the generating of content unit data comprises:
bundling external input data in units of a service data unit for each service flow, and allocating one multicast connection identification to each of the bundled data to generate payload data of a content unit for multicast broadcasting; and
attaching a Generic Routing Encapsulation (GRE) header and an IP header to the payload data.

3. The synchronization control method of claim 1, wherein the generating of a sync rule comprises analyzing the payload data and the data with the GRE header attached thereto to generate the sync rule.

4. The synchronization control method of claim 1, wherein the sync rule notification message comprises: a control rule which configures an MAC packet data unit, a scheduling rule for determining a physical burst allocation zone in a physical permutation zone, and a timing control rule for determining an MAC burst generation time.

5. The synchronization control method of claim 1, further comprising retransmitting the sync rule notification message to a corresponding base station when one or more base station of the base stations requests retransmission of the sync rule notification message.

6. A multicast and broadcast synchronization control method in a base station, comprising:
receiving content unit data for multicast broadcasting and a sync rule notification message comprising sync rule information from an access network gateway;
converting the received content unit data for multicast broadcasting into data of a physical burst unit capable of being wirelessly transmitted to a mobile terminal; and
transmitting the converted data of the physical burst unit to the mobile terminal in synchronization with a transmission time of another base station, on the basis of the sync rule information.

7. The multicast and broadcast synchronization control method of claim 6, wherein the converting of the received content unit data comprises:
generating an MAC packet data unit and data of an MAC burst unit with the content unit data for multicast broadcasting;
allocating the MAC packet data unit and the data of the MAC burst unit to a physical permutation zone in units of a physical burst unit, according to a physical burst allocation zone scheduling rule comprised in a sync rule notification message received from the access network gateway; and
transmitting the physical burst to the mobile terminal to be synchronized with the other base station at certain timing intervals.

8. The multicast and broadcast synchronization control method of claim 6, wherein the transmitting of the converted data comprises:
storing the data of the physical burst unit in a buffer in order of generation; and
transmitting the data of the physical burst unit, stored in the buffer, to the mobile terminal to be synchronized with the other base station at certain timing intervals.

9. The multicast and broadcast synchronization control method of claim 6, further comprising requesting retransmission of the sync rule notification message to the access network gateway when the sync rule notification message is not received from the access network gateway.

10. An access network gateway apparatus for controlling multicast and broadcast synchronization, comprising:
a data distributor configured to generate content unit data for multicast broadcasting with input data, and distribute and transmit the content unit data to a plurality of base stations; and
a sync controller configured to generate sync rule information to be executed by the base stations on the basis of the content unit data of multicast broadcasting output from the data distributor, add the sync rule information into a sync rule notification message, and transmit the sync rule notification message to the base stations.

11. The access network gateway apparatus of claim 10, wherein the data distributor bundles the input data in units of a service data unit for each service flow, allocates one multicast connection identification to the bundled data to generate content unit data for multicast broadcasting, and generic-routing-encapsulates the content unit data.

12. The access network gateway apparatus of claim 10, wherein the sync controller receives non-encapsulated content unit data for multicast broadcasting from the data distributor to generate a sync rule.

13. A base station apparatus for controlling multicast and broadcast synchronization, comprising:
a data receiver configured to receive content unit data for multicast broadcasting from an access network gateway to output payload data in which a header has been removed from the received data;
an upper sync executor configured to receive a sync rule notification message comprising sync rule information from the access network gateway, and generate an MAC packet data unit and an MAC burst with the payload data output from the data receiver according to the sync rule information; and
a lower sync executor configured to generate data of a physical burst unit with the MAC packet data unit and the data of the MAC burst unit, and transmit the generated data to one mobile terminal to be synchronized with another base station at certain timing intervals according to the sync rule information.

14. The base station apparatus of claim 13, wherein the lower sync executor stores the data of the physical burst unit in a buffer in order of generation, and transmits the data of the physical burst unit, stored in the buffer, to the mobile terminal to be synchronized with the other base station at certain timing intervals.

15. The base station apparatus of claim 13, wherein the upper sync executor requests retransmission of the sync rule notification message to the access network gateway when the sync rule notification message is not received from the access network gateway.
